(19) United States
(12) Patent Application Publication
(10) Pub. No.: US 2019/0210730 A1
(43) Pub. Date: Jul. 11, 2019

(54) GALLEY MONUMENT WITH ELECTRICAL LOCKING FOR AN AIRCRAFT OR SPACECRAFT

(71) Applicant: AIRBUS OPERATIONS GMBH, Hamburg (DE)

(72) Inventors: Christian RIEDEL, Hamburg (DE); Michael LUEDTKE, Hamburg (DE)

(21) Appl. No.: 16/241,122

(22) Filed: Jan. 7, 2019

(30) Foreign Application Priority Data
Jan. 8, 2018 (DE) 10 2018 200 141.3

(51) Int. Cl. B64D 11/04

(52) U.S. Cl. CPC B64D 11/04

(57) ABSTRACT

A galley monument with electrical locking includes a compartment to receive a galley component. A catch is movable between a closed position and an open position, wherein, in the closed position, the catch locks a galley component situated in the compartment in the compartment and, in the open position, the catch opens up the compartment for the receiving and removal of a galley component. An electromechanical actuator can move the catch between the closed position and the open position.

### CROSS-REFERENCE TO RELATED APPLICATION

This application claims priority to German Patent Application No. 10 2018 200 141.3 filed Jan. 8, 2018, the entire disclosure of which is incorporated by reference herein.

### TECHNICAL FIELD

The disclosure herein relates to a galley monument with electrical locking for a vehicle, in particular an aircraft or spacecraft. The disclosure herein also relates to an aircraft or spacecraft having a galley monument of the type.

Although usable in a wide variety of applications, the disclosure herein and the problem on which it is based will be discussed in more detail with regard to passenger aircraft. The devices described may however likewise be used in different vehicles and in all sectors of the transport industry, for example for road vehicles, for rail vehicles, for aircraft or for watercraft.

### BACKGROUND

Galleys of passenger aircraft typically comprise one or more galley monuments, that is to say individual galley modules, which commonly have a monolithic basic structure and provide a variety of functions in an integrated manner. For example, a galley monument of the type may comprise a variety of galley components for the preparation of meals and/or beverages in an extremely small space, for example hot water boilers, coffee machines, convection ovens, cooking plates, sinks, cooling vessels, refrigerators etc. In conventional embodiments, galley monuments furthermore have a multiplicity of compartments for receiving containers and/or roller containers (“trolley” or “galley cart”). To secure the containers in their position within the respective compartment, use is made, in typical embodiments, of one or more mechanical catches which are operated manually by the cabin crew. For example, the catches are opened in order for a container to be pushed in, and are closed again in order to fix a container that has been pushed into a compartment. Here, it is one of the duties of the cabin crew to monitor and ensure at all times that the containers and roller containers are correctly locked in the galley monuments.

Documents DE 10 2009 058 327 A1 and U.S. Pat. No. 8,378,825 B2 describe systems and methods for storage in an aircraft galley. Here, receiving devices such as boxes or trolleys are equipped with a transponder which is designed to output an identification signal which is characteristic of the content of the receiving device to which the transponder is attached.

### SUMMARY

Against this background, it is an object of the disclosure herein to find automated solutions for the secure locking of galleys.

According to the disclosure herein, the object is achieved by a galley monument and by an aircraft or spacecraft having features disclosed herein.

Accordingly, a galley monument with electrical locking is provided. The galley monument comprises a compartment which is designed to receive a galley component; a catch which is designed to be movable between a closed position and an open position, wherein, in the closed position, the catch locks a galley component situated in the compartment in the compartment and, in the open position, the catch opens up the compartment for the receiving and removal of a galley component; and an electromechanical actuator which is designed to move the catch between the closed position and the open position.

An aircraft or spacecraft having a galley is also provided. The galley comprises at least one galley monument according to the disclosure herein.

A concept on which the disclosure herein is based involves supplementing the hitherto purely mechanically designed locking of galleys to include electrically operated actuators in order to thus permit automated locking. For this purpose, a catch of a compartment can be moved by an electromechanical actuator from a closed position into an opened position and vice versa. When the catch is closed, a galley component such as for example a container or a roller container that has been introduced into the corresponding compartment is fixedly held in the compartment by the catch. In a closed state, the catch or the bearing arrangement thereof (for example a ball bearing or rotary bearing) absorbs mechanical loads, which are absorbed from the containers or roller containers, which are in principle freely movable, during movements of the galley or of the aircraft.

On the one hand, the solution according to the disclosure herein now offers the advantage that it can be ensured at all times that the catch is in fact correctly closed (or opened). If this is not the case, the catch can be moved into a desired position at any time by the actuator. In particular, the catch according to the disclosure herein and the associated actuator may be designed such that the catch furthermore likewise remains movable purely mechanically, that is to say manually, between the closed position and the opened position. In this case, it may for example be provided in one embodiment that the electromechanical actuator is activated only when the catch is not situated in a closed position, for example because it has not been moved, or has not been moved fully, into the closed position owing to an error or oversight by the cabin crew. This may for example be made dependent on whether or not a container or some other galley component is situated in the compartment. Furthermore, the actuator may be connected to a control system of the galley, by which the actuator and further catch actuators can be activated centrally, for example via a user interface. The control system of the galley itself may in turn be connected to a cabin management system.

Advantageous embodiments and refinements are disclosed herein and with reference to the figures.

In one refinement, the electromechanical actuator may have an actuator element. The actuator element may comprise a shape memory alloy. Shape memory alloys (SMA) or memory metals are particularly advantageous for the present usage situation, because, on the basis of these, it is possible to implement an actuator arrangement in an extremely small installation space and with minimal weight. For example, a magnetic shape memory alloy may be used which undergoes a magnetically induced change in shape or length, which in turn can be utilized for a transmission of force in order to move the catch.

In one refinement, a coder may be provided. The coder may be designed as a measuring transducer for determining a present position and/or a present orientation of the catch. Correspondingly, the coder may for example be designed as a rotary and/or linear coder. The coder may for this purpose for example detect the position or orientation optically, electrically, magnetically and/or mechanically and output it as an electrical signal, for example through evaluation of a magnetic field modulation by inductive sensors, Hall sensors or the like. For this purpose, the coder may for example be designed as an incremental coder, that is to say may have solid measures for counting, by which a travel distance and/or a travel direction and/or a change in angle or direction of rotation is detected. Alternatively or in addition, further known solutions are likewise provided, such as for example continuously operating measuring systems, absolute value coders etc. The electromechanical actuator may likewise, in one specific example, be electromagnetically triggered or driven, for example by a stepper motor, servo motor or the like. The coder may generally be utilized to detect the present position and/or alignment of the catch and/or of the actuator and compare this with a desired reference position or alignment, for example a preset closed or opened position. In the event of deviations with respect to the desired position, the catch can be correspondingly moved into the correct position by the actuator. This may be performed for example by a control unit.

In one refinement, a component detector may be provided. The component detector may be designed to detect a presence of a galley component in the compartment. A variety of technologies are provided here for the implementation of the component detector. In one specific example, the component detector may utilize RFID (radio frequency identification) technology, for example by near field communication (NFC). For this purpose, the galley components may correspondingly be equipped with one or more active and/or passive RFID transponders. The component detector may for example be formed within the compartment or at the edge at an opening of the compartment, such that a container or a roller container can be directly detected when introduced into the compartment. In specific embodiments, it is thus for example also possible for additional pieces of information or data to be read out from the corresponding galley component, which pieces of information or data may be stored on a corresponding data memory, coupled to the RFID transponder, on the galley component. For example, such pieces of data may include specifications regarding the content and/or the state of the galley component. In other examples, further detector or sensor technologies are alternatively or additionally provided for detecting the presence of a galley component in the compartment, for example optical, infrared, ultrasound-based, using mechanical switches etc. The knowledge of the presence of a galley component can in turn be utilized, for example, to automatically close those catches into whose associated compartments a galley component has been introduced.

In one refinement, a control unit may be provided. The control unit may be designed to control the electromechanical actuator for the movement of the catch. The control unit may for this purpose for example comprise an activation device, a decoder/encoder unit, a data memory, a microprocessor etc. For example, a galley may be formed with multiple galley monuments, which each comprise an individual control unit. The individual control units of the galley monuments may in turn be controlled jointly with one another in closed-loop or open-loop fashion by a central controller. It is however alternatively likewise possible for a central controller of the galley to directly perform the control of the individual galley monuments.

In one refinement, the control unit may be designed or configured to wirelessly exchange locking data with the electromechanical actuator, the coder and/or the component detector. For example, a wireless local network, such as for example a radio network, may be utilized to communicate data between the individual components. For example, the electromechanical actuator may be wirelessly connected to the control unit via a radio module or the like.

In one refinement, the control unit may be wired to exchange locking data with the electromechanical actuator, the coder and/or the component detector. It is basically thus possible, aside from an electrical connection of the actuator, for further cable connections such as a data cable etc. to be provided. To ensure electromagnetic compatibility (EMC), it is for example possible for shielded cables or lines, circuit boards and circuits to be used.

In one refinement, the control unit may be designed or configured to evaluate a present position of the catch, a present orientation of the catch and/or a presence of a galley component in the compartment. The control unit may be designed or configured to control the electromechanical actuator on the basis thereof. For example, provision may be made for all of those catches of the galley monuments of a galley into whose associated compartment a galley component has been introduced to be automatically closed. In one example, provision may be made for the catches to be automatically closed after a predefined time window has expired, if this has not already been performed manually in the intervening time.

In one refinement, a display unit may be provided. The display unit may be coupled to the control unit and designed to display locking data. For example, a galley may be formed with multiple galley monuments which each have a dedicated display unit. It is however alternatively likewise possible for a central display unit to be provided for the entire galley.

In one refinement, the display unit may be designed as a touchscreen for the input and output of control commands of the control unit. For example, a touchscreen may be attached to the galley and/or to the galley monuments, by which touchscreen all or certain galley monuments can be controlled. In principle, such displays and/or control units may be incorporated into and/or connected to a cabin management system.

In one refinement, the compartment may have at least two catches and associated electromechanical actuators. In principle, embodiments with exactly two catches, but likewise with three, four or more catches are provided, which catches are each movable by an associated electromechanical actuator.

In one refinement, the galley component may be a container or a roller container or the like.

In one refinement, the galley monument may be designed with a multiplicity of compartments with associated catches and electromechanical actuators.

The above embodiments and refinements may be combined with one another in any desired manner where expedient. Further possible embodiments, refinements and implementations of the disclosure herein also encompass combinations, which have not explicitly been mentioned, of features of the disclosure herein described above or below with regard to the exemplary embodiments. In particular, here, a person skilled in the art will also add individual aspects as improvements or supplements to the respective basic form of the disclosure herein.

### BRIEF DESCRIPTION OF THE DRAWINGS

The disclosure herein will be discussed in more detail below on the basis of the exemplary embodiments specified in the schematic figures. In the figures:

FIG. 1 shows a schematic front side view of a galley with electrical locking with multiple galley monuments according to one embodiment of the disclosure herein;

FIG. 2 shows a schematic view of the locking system of the galley from FIG. 1;

FIG. 3 shows a schematic view of a locking system of a galley according to an alternative embodiment of the disclosure herein;

FIG. 4 shows schematic views of a catch from FIG. 3;

FIG. 5 shows a schematic side view of an aircraft with the galley from FIG. 1; and

FIG. 6 shows a schematic flow diagram of a method for controlling the galley from FIG. 1.

The appended figures are intended to impart further understanding of the embodiments of the disclosure herein. They illustrate embodiments and serve, in conjunction with the description, for explaining principles and concepts of the disclosure herein. Other embodiments, and many of the stated advantages, will emerge with regard to the drawings. The elements of the drawings are shown not necessarily to scale with respect to one another.

In the figures of the drawing, elements, features and components which are identical, functionally identical and of identical action are each denoted by the same reference designations unless stated otherwise.

### DETAILED DESCRIPTION

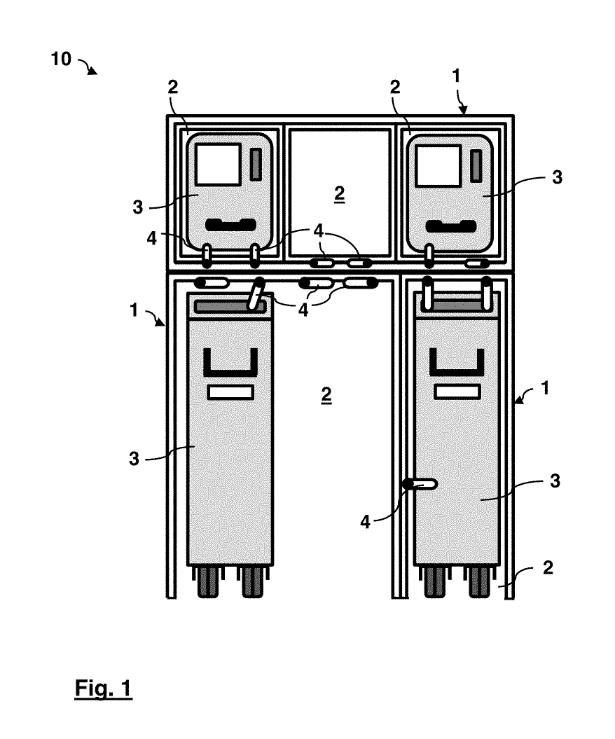

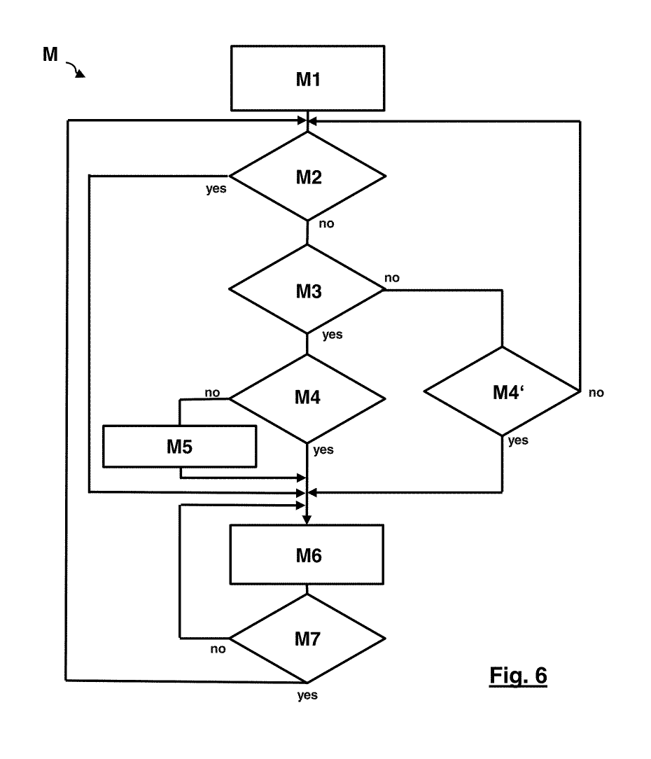

FIG. 1 shows a schematic view of a galley 10 with multiple galley monuments 1 according to an embodiment of the disclosure herein. The galley 10 may for example be provided in a passenger cabin of an aircraft 100, in particular of a passenger aircraft, as illustrated by way of example in FIG. 5.

In this embodiment, the galley 10 is divided, purely by way of example, into three galley monuments 1. Each of these galley monuments 1 has one or more compartments 2 designed for receiving one or more galley components 1. One of the galley monuments 1 (at the bottom left in FIG. 1) has a compartment 2 for receiving two galley components 3, in this case two roller containers. In the galley monument to the right thereof (at the bottom right in FIG. 1), there is formed a compartment 2 for only a single roller container. Above these two galley monuments 1 there is arranged a third galley monument 1 which can receive three containers as galley components 3 in in each case one compartment 2, for example food containers. The compartments 2 may for example have standardized dimensions for receiving standardized containers or the like.

At each of the compartments 2, two to three catches 4 are attached to the respective galley monument 1. Each of these catches 4 is designed to be movable between a closed position and an open position. In the closed position, a galley component 3 situated in the compartment 2 is locked or held fixed in the compartment 2 by the catch 4. In the open position, the catch opens up the compartment 2 for the receiving and removal of a galley component 3. For example, in the galley monument 1 at the bottom left in FIG. 1, a roller container is held by one catch 4 (at the top right on the galley component 3). However, the catch 4 has not been correctly closed, as can be seen from a slightly oblique position. A second catch 4 situated to the left of the catch 4 is still situated in an opened position. By contrast, the galley component 3 in the galley monument 1 at the bottom right has been correctly locked with the galley monument 1 by the three catches 4 provided here. Depending on the intended use, a person skilled in the art will use one, two, three or more catches 4 per compartment 2. For example, in the aviation sector, for the purposes of redundancy, it is advantageous to provide at least two catches 4.

The present solution now provides, for each of the catches 4 shown, a corresponding electromechanical actuator 5 which is designed to move the corresponding catch 4 between the closed position and the open position. This will be discussed in detail with reference to the further figures.

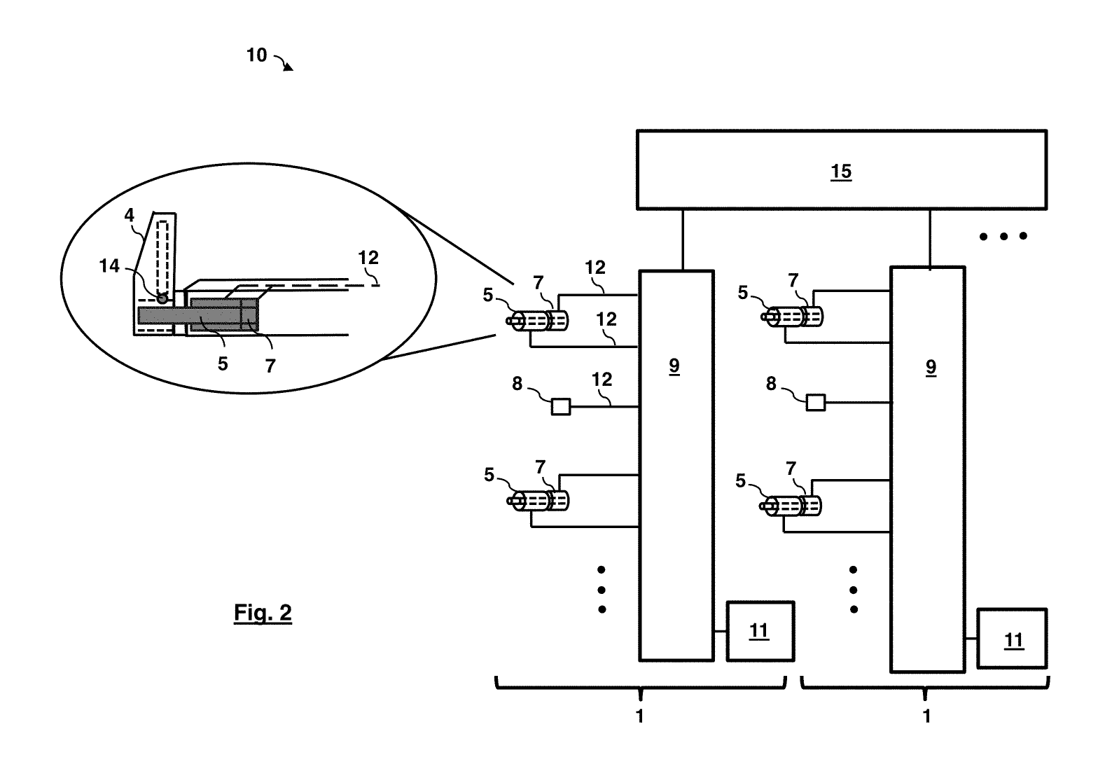

FIG. 2 shows a schematic view of the locking system of the galley 10 from FIG. 1. Each of the galley monuments 1 of the galley 10 comprises multiple catches 4, which are coupled to an electromechanical actuator 5. FIG. 2 shows selected components of the system merely by way of example. At the left in the figure, one catch 4 is illustrated in detail in a sectional view together with the associated electromechanical actuator 5, whereas, at the right in the figure, electromechanical actuators 5 relating to the further catches 4 are schematically indicated merely by way of example. The electromechanical actuators 5 may for example be stepper motors or servo motors or the like, which can rotate the associated catch 4 through an angle of for example ±90°, 180° or 270° or the like in order to move the catch from a closed position into an open position and vice versa. It will be clear here to a person skilled in the art that other angle values may also be provided. Furthermore, each catch 4 may have a magnetic contact 14 or the like as reference point, by which it is possible in an extremely simple manner to detect which specific position and/or orientation the catch 4 is presently situated in. For example, a magnetic field modulation may be evaluated by inductive sensors, Hall sensors or the like in order to detect the position and/or orientation of the catch 4. It will be clear here to a person skilled in the art that, for adequate accommodation of force and/or transmission of force, a gearing such as a planetary gearing or the like may additionally be provided (not shown here), wherein an encapsulated construction may for example be provided.

Furthermore, for each of the catches 4, a coder 7 is provided which is designed as a measuring transducer for determining at least one of a present position and a present orientation of the catch 4. For this purpose, the coder 7 is coupled directly to the electromechanical actuator 5. The two components are connected by a cabling 12 to a control unit 9. The cabling 12 may for example comprise not only electrical cables but also data lines or the like. Each galley monument 1 has a dedicated control unit 9, which is designed in each case to control the electromechanical actuators 5 of the galley monument 1 for the movement of the associated catches 4. FIG. 2 shows, by way of example, two control units 9 of two of the galley monuments 1 from FIG. 1, wherein, for each control unit 9, in each case by way of example two electromechanical actuators 5 with coders 7 coupled thereto are shown (further control units 9 and actuators 5 and coders 7 are indicated by dots). It is additionally possible, for example, for not only the present position and/orientation but likewise an absolute starting and/or end position of the catch 4 to be determined. In general, one or more absolute reference points for the catch 4 may be established or determined by a corresponding sensor. In principle, such a reference point may be measured optically, electromagnetically, mechanically etc.

Each galley 1 furthermore has a component detector 8 which is designed to detect a presence of a galley component 3 in one or more associated compartments 2. The component detector may for example be an infrared sensor, an optical sensor (for example a light barrier), an RFID sensor, an ultrasound sensor etc. The respective control unit 9 is likewise wired to the respective component detector 8.

The control units 9 are each designed to exchange locking data with the components, that is to say with the electromechanical actuators 5, the coders 7 and/or the component detector 8, and to control the electromechanical actuators 5 on the basis of this and thus correspondingly adjust the catches 4. Such locking data may for example include present positions and/or orientations of the catch is 4 or absolute reference points of the catches 4. Furthermore, the locking data may include a presence of one or more galley components 3 in one or more of the compartments 2.

In this exemplary embodiment, each galley monument 1 furthermore has a display unit 11, which is coupled to the control unit 9 and which is designed to display the locking data. In particular, the display unit 11 may be a touchscreen or the like, which may be designed in particular for the input and output of control commands of the control unit 9. Control units 9 or activation devices of the individual galley monuments 1 are, in the embodiment of FIG. 2, governed by a central controller 15 of the galley 10. In alternative embodiments, provision may likewise be made for the galley 10 to have only one superordinate display unit 11, by which each of the galley monuments 1 can be controllable. For example, the display unit 11 may, as an adjustable touch display, be articulated in an adjustable manner on one of the galley monuments 1. The central controller 15 may for example be connected to a controller area network (CAN) of a cabin management system or the like.

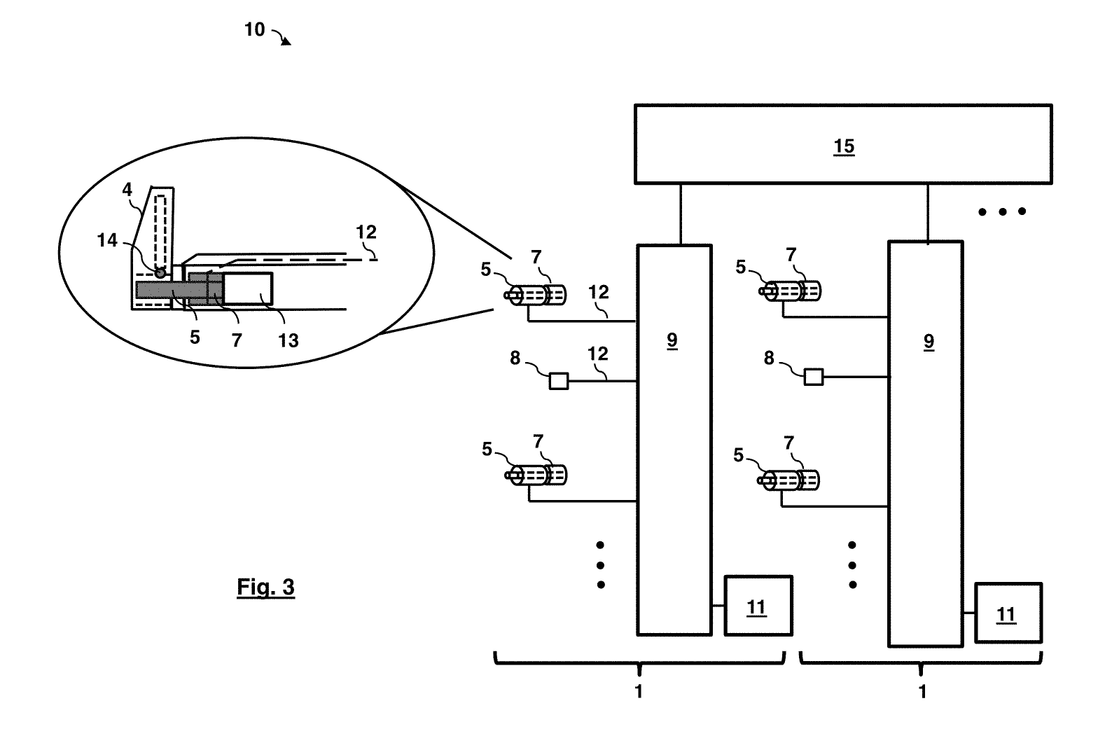

FIG. 3 shows a schematic view of a locking system of a galley 10 according to an alternative embodiment of the disclosure herein. By contrast to the galley in FIG. 2, the electromechanical actuators 5 in this embodiment are not connected via data cables to the control units 9 of the galley monuments 1. Rather, each of the electromechanical actuators 5 has a wireless connection 13 to the rest of the system, in particular to the control units 9. In relation to the embodiment in FIG. 2, this offers the advantage that cables can be omitted. It is possible for only the electrical supply for the electromechanical actuators 5 to continue to be realized for example via cables or wires. In this way, installation volumes and effort and also weight and thus ultimately costs are saved.

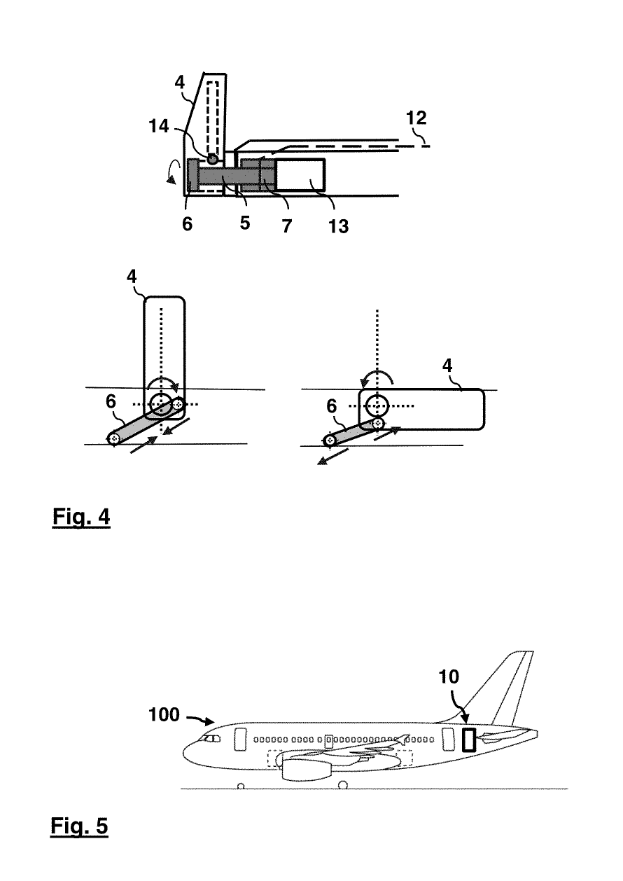

FIG. 4 shows multiple schematic views of one of the catches 4 from FIG. 3 or FIG. 2 (sectional view at the top in FIG. 4, and two front views at the bottom in FIG. 4). The electromechanical actuator 5 of the catch has, in this embodiment, an actuator element 6 which comprises a magnetic shape memory alloy. The actuator element 6 expands and contracts in the presence of magnetic excitation. The actuator element 6 is, at one side, coupled to the catch 4 such that a change in length of the actuator element 6 effects a rotation of the catch 4 through 90°, whereby the catch is moved between an opened position and a closed position.

FIG. 6 shows a schematic flow diagram of a method M for controlling the galley 10 from FIG. 1.

The method M comprises, under M1, checking which of the catches 4 of the galley 10 are to be locked. This information may, in one example, be read out from a central database which is communicatively connected to the central controller 15 of the galley 10. Alternatively or in addition, this information may also be obtained directly through detection, by the component detectors 8, of which of the compartments 2 a respective galley component 3 has been introduced into and must accordingly be correctly locked.

The method M furthermore comprises, under M2, checking whether or not control of one or more of the catches 4 is being performed via one or more display units 11 (for example touch panel) or a general user interface (which may for example be connected to a cabin management system). If this is the case, then in a next step under M6, the corresponding catches 4 are directly activated or adjusted. For this purpose, the method M furthermore comprises, under M7, checking all of the catches 4 as regards whether these are in the intended position. If this is not the case, the method returns to M2.

If the check under M2 yields that no input is being given via a user interface, then it is checked under M3 whether or not a galley component 3 is situated in the respective compartment 2. If no galley component 3 is situated in the compartment 2, then, under M4′, an adjustment of the one or more associated catches 4 is triggered only on the basis of a manual movement. If a galley component 3 is situated in the compartment 2, then the one or more catches 4 can initially, under M4, be manually adjusted. Only if this manual adjustment does not take place or does not take place correctly (for example because the catch 4 is not moved into its end position), then, under M5, after a defined time delay, an automatic movement of the one or more catches 4 can be triggered by the control unit 9 or the central controller 15 under M6.

This method M can be performed until all of the catches 4 of the galley 10 have been correctly closed. It is evident to a person skilled in the art that the specified method M is to be understood merely as an example. Numerous further variants are possible and provided depending on the application. For example, provision may be made for all of the catches 4 to be automatically closed irrespective of whether or not galley components 3 are present, for example in an emergency situation or during turbulence or the like.

In the above detailed description, various features have been summarized in one or more examples in order to improve the stringency of the illustration. It should however be clear here that the above description is of a merely illustrative and in no way restrictive nature. It serves for covering all alternatives, modifications and equivalents of the various features and exemplary embodiments. Numerous other examples will be immediately and readily clear to a person skilled in the art on the basis of his or her technical knowledge in the light of the above description.

The exemplary embodiments have been selected and described in order to be able to illustrate as best as possible the principles that form the basis of the disclosure herein, and the possible uses thereof in practice. As a result, experts can optimally modify and utilize the disclosure herein and its various exemplary embodiments with regard to the intended use. In the claims and in the description, the expressions “containing” and “having” have been used as linguistically neutral terms for the corresponding expressions “comprising”. While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE DESIGNATIONS

1 Galley monument
2 Compartment
3 Galley component
4 Catch
5 Electromechanical actuator
6 Actuator element
7 Coder
8 Component detector
9 Control unit
10 Galley
11 Display unit
12 Cabling
13 Wireless connection
14 Magnetic contact
15 Central controller
100 Aircraft
M1 Method step
M2 Method step
M3 Method step
M4, M4′ Method step
M5 Method step
M6 Method step
M7 Method step

1. A galley monument with electrical locking, the gallery monument comprising:
a compartment for receiving a galley component;
a catch movable between a closed position and an open position, wherein, in the closed position, the catch locks a galley component situated in the compartment in the compartment and, in the open position, the catch opens up the compartment for the receiving and removal of a galley component; and
an electromechanical actuator to move the catch between the closed position and the open position.

2. The galley monument according to claim 1, wherein the electromechanical actuator has an actuator element which comprises a shape memory alloy.

3. The galley monument according to claim 1, comprising:
a coder configured as a measuring transducer for determining at least one of a present position and a present orientation of the catch.

4. The galley monument according to claim 1, comprising:
a component detector for detecting a presence of a galley component in the compartment.

5. The galley monument according to claim 1, comprising:
a control unit for controlling the electromechanical actuator for movement of the catch.

6. The galley monument according to claim 5, wherein the control unit is configured to wirelessly exchange locking data with at least one of the electromechanical actuator, the coder and the component detector.

7. The galley monument according to claim 5, wherein the control unit is wired to exchange locking data with at least one of the electromechanical actuator, the coder and the component detector.

8. The galley monument according to claim 5, wherein the control unit is configured to evaluate at least one of a present position of the catch, a present orientation of the catch and a presence of a galley component in the compartment, and to control the electromechanical actuator on a basis thereof.

9. The galley monument according to claim 5, comprising:
a display unit coupled to the control unit and configured to display locking data.

10. The galley monument according to claim 9, wherein the display unit comprises a touchscreen for input and output of control commands of the control unit.

11. The galley monument according to claim 1, wherein the compartment has at least two catches and associated electromechanical actuators.

12. The galley monument according to claim 1, wherein the galley component is a container or a roller container.

13. The galley monument according to claim 1, wherein the galley monument comprises a multiplicity of compartments with associated catches and electromechanical actuators.

14. An aircraft or spacecraft having a galley which comprises at least one galley monument according to claim 1.
